(19) United States
(12) Patent Application Publication
(10) Pub. No.: US 2007/0241928 A1
(43) Pub. Date: Oct. 18, 2007

(54) Wireless Remote Control

(75) Inventors: Michael Dennis Hardwick, Dorchester (GB); James Bickerton, Devizes (GB); John Bickerton, Devizes (GB)

Correspondence Address: Arthur Jacob, 25 East Salem Street, P.O. Box 686, Hackensack, NJ, 07602, US

(73) Assignee: Intelligent Electronics (Intellectual Property) Li, Dorchester (GB)

(21) Appl. No.: 10/576,336

(22) PCT Filed: Oct. 19, 2004
(86) PCT No.: PCT/GB04/04403

§ 371 Date: Mar. 28, 2007

(30) Foreign Application Priority Data
Oct. 20, 2003 (GB) 0324349.0
Nov. 4, 2003 (GB) 0325711.0

(51) Int. Cl. G08C 17/00

(52) U.S. Cl. 340/825.72

(57) ABSTRACT

Lighting units (22) in a room (20) are controlled automatically and remotely in response to motion sensor modules (26) located to cover the area of the room (20). A sensor module (26) detecting movement transmits a radio signal to a controller module (28), which then transmits a corresponding control signal to the responder modules (24), causing them to switch their associated lighting units on and then increase their brightness to a preset level. The system includes an emergency lighting responder module (32) to switch on emergency lighting (34) if mains power fails and is also responsive to ambient light level. Each of the controller module (28), the sensor modules (26) and the responder modules (24) include a radio transceiver and all control and management signals are transmitted from location to location by radio. Other sensor modules (responsive to different variables) and responder modules may be added to build up a wireless building management system.

This invention concerns the remote control of devices such as items of electrical apparatus, especially but not exclusively for reducing the power consumed thereby.

Many premises, such as factories, shops and offices, contain electrical apparatus that needs to be on for only a portion of each day. A cold drinks dispenser in a factory, for instance, needs to be on (cooling the drinks it contains) during the hours when the factory is in an open state—that is, when staff are working on the premises; but such a cold drinks dispenser does not need to be on when the factory is in a closed state—that is, when it is unoccupied, say at night. The same applies, of course, to hot drinks dispensers and a wide range of other apparatus including air conditioning units, space heaters, water heaters, fans, lights and so forth.

Energy and costs are saved if such items of apparatus are switched off when not required. Two known ways of doing this are (a) to appoint somebody to go around the premises and switch the apparatus on and off as appropriate and (b) to connect the apparatus to the power supply by means of time switches. Both of these approaches have problems, as will now be explained.

Appointing somebody to switch the apparatus on and off may be relatively expensive, especially if the person appointed is of a management grade (it being currently common in business for senior staff to be first to arrive and last to leave). It draws that person away from normal duties, which is contrary to good management practice. It calls for additional organisation, particularly in covering for sickness and holidays. And it presents a practical problem in that many kinds of apparatus such as drinks dispensers are deliberately arranged to shield access to their connections with the power supply, for safety and to deter tampering. Finally, the person appointed may become neglectful of the task over time, especially if nobody else notices whether or not the task is being properly performed.

The problems outlined above in relation to manual switching may be overcome by the use of time switches, but at the cost of introducing other problems. First, time switches inherently work on a routine, changing from on to off at set times of the day, and thus they do not offer any flexibility with regard to use of premises: they do not, for instance, adapt to early opening or late closing. In any event, time switches need to be reset twice a year, when clocks are seasonally adjusted. Also, unless the time switch is sophisticated enough (and therefore expensive) to be programmable for a whole week, it will treat weekends and holidays as normal working days and an appliance connected to it will be switched on even though the premises are closed.

The various problems of manual switching and time witching may be overcome by automated remote control using radio communication. A system for this, with switching controlled by the state of a register such as an intruder alarm, is disclosed in our copending European patent application EP 01 921 646.4. Another system, in which apparatus is controlled automatically in response radio signals representing ambient temperature or light level or some other variable, is disclosed in our copending international patent application PCT/GB2004/003427.

The present invention can be implemented as a building management system in which all communication among sensor modules, controller modules and responder modules is wireless. Originally, all building management systems used wired communication, as this was considered reliable and less susceptible to interference. However the techniques of the present invention provide both reliability and resistance to interference, and additionally more flexibility in system configuration and an ability to reconfigure a system without extensive building refurbishment.

The wireless system of the present invention contrasts with wired systems and goes well beyond what has hitherto been achieved in using wireless communication in limited parts of a building management system, for instance the use of 2.4 GHz radio for exchange of data between two wired modules as disclosed in US patent application 20010055965.

It is an object of the present invention to provide a remote control system using radio communication which has wide applicability in the control of apparatus.

Thus according to a first aspect of the present invention there is provided a control system for controlling apparatus remotely in response to changes of a variable, characterised in that said control system comprises a sensor module to sense the variable, a controller module operatively associated with the sensor module and including a radio transceiver operative to transmit a control signal when the variable changes and to transmit and receive system management signals, and a responder module arranged remote from the controller module and including a radio transceiver operative to receive the control signal and to receive and transmit system management signals.

The sensor module may sense the presence or absence of users of the controlled apparatus, either through a passive infra-red detector or the like or by means of connection to an intruder alarm. The controlled apparatus may comprise electrical lighting which is turned on when persons are present and turned off when persons are absent. The sensor module may sense electrical mains power and the controlled apparatus comprise emergency lighting arranged to be turned on if the electrical mains power fails.

The variable may be a natural variable. Thus the controlled apparatus may comprise heating apparatus or cooling apparatus controlled in response to ambient temperature. Otherwise the controlled apparatus may comprise electrical lighting apparatus controlled in response to ambient light level. Such electrical lighting apparatus may comprise a fluorescent unit including a dimmable ballast operatively associated with the responder module and adjustable thereby, and adjustment of the dimmable ballast by the responder module may be such that the perceived output of the fluorescent unit varies substantially linearly.

To enable the system to be extended, the responder module may comprise a repeater for the signals.

To reduce system costs, the radio transceiver of the controller module is preferably of the same form as the radio transceiver of the responder module.

Preferably the system of the invention is arranged for control of apparatus comprising a plurality of units, in which case the system comprises a plurality of said sensor modules respectively responsive to a plurality of said variables and a plurality of responder modules respectively associated with said units.

At least some of said sensor modules may sense mutually different variables.

Those skilled in the science will now appreciate that a system according to the present invention allows many different units of apparatus (lights, space heaters, water heaters, chillers, computers and so forth) in different locations to be controlled according to changes in a variety of variables (ambient temperature, light level, presence or absence of personnel and so forth). In effect the system can substitute for a building management system without the need for the extensive and expensive wiring conventionally associated with building management systems. By way of illustrating the versatility of the present invention, the system may be arranged on its input side so that a said sensor module senses (a) the presence or absence of users of a said device, through a passive infra-red (PIR) device or the like, or through an input from an intruder alarm, (b) ambient temperature or ambient light level and/or electrical mains power supply. On its output side the system may be arranged to control electrical lighting (including emergency lighting), heating or cooling apparatus and/or any other apparatus that needs to be controlled, whether for energy saving or other purposes.

The controller module is preferably operative to transmit a plurality of control signals respectively corresponding to sensed changes of said variables.

To ensure orderly organisation of the system, the system management signals preferably include identity signals individual to the responder modules. The system management signals may also include identity signals individual to a set of responder modules arranged in a group or a zone, which set can be switched on and off together. The identity signals each comprise four hexadecimal digits, to permit a large number of individual identities.

Preferably the controller module includes a status array recording the proper status of the responder modules (that is, the status which each responder module is intended to have). The controller module may also include reset means operative to check the actual status of each responder module against the recorded status and to indicate any discrepancy. The controller module may be operative to switch units of the controlled apparatus on and off alternatively by transmitting a global switch control signal associated with the identity signals of the corresponding responder modules followed by status request signals to those responder modules seriatim. With this arrangement each responder module is preferably arranged to respond to its status request signal by transmitting an actual status signal for receipt by the controller module and comparison with the record in the status array. If for any responder module there is a discrepancy between the actual status and the record, the controller module may transmit a correction signal to change the status of that responder module to its proper status. Then the responder module may transmit a confirmation signal to the controller module, and if no such confirmation signal is received by the controller module the responder module concerned may be recorded as faulty.

Preferably the control system includes a computer and an interface whereby control and/or management information of the system is delivered to and/or from the computer. To enable the system to work with a general purpose personal computer (PC) the interface preferably utilises a command language suitable for a PC, such as RS232 or Ethernet. As well as receiving information from the system, the computer is preferably also operable to supply control and/or management information. To this end the computer may conveniently include a graphical user interface (GUI) whereby said control and/or management information is supplied.

The system with computer may have a schedule under which the control of the apparatus varies with time. For this purpose the system preferably includes a calendar and or a timer. The computer may be programmable (a) to define the system schedule, (b) to partition the system into groups and/or zones, (c) to define identity signals for specific responder modules and/or (d) to define the response of a specific responder module.

A control system according to the invention may comprise a plurality of controller modules. Each such controller module may be operatively associated with all said sensor modules, to provide improved reliability through redundancy. Alternatively each such controller module may be operatively associated with a set of said sensor modules.

Whilst the system may include an interface for operative connection to a building management system, it is itself preferably configured and arranged to operate as an independent building management system, with all communication wireless.

According to a second aspect of the present invention there is therefore provided a building management system comprising a plurality of sensor modules operative at a plurality of sensor locations to sense one or more variables, each sensor module in use transmitting from its location radio control signals related to its sensed variable, and a plurality of responder modules operative at a plurality of responder locations to control apparatus, each responder module in use receiving radio control signals related to the variables sensed by the sensor modules and controlling said apparatus automatically in response thereto, characterised in that the sensor modules and responder modules are mutually similar in including a common radio transceiver and signal processor and mutually different in including specific functional variations.

Such a building management system preferably includes a controller module operative to receive radio control signals from the sensor modules and to transmit radio control signals to the responder modules, and the controller module may be similar to the sensor modules and the responder modules in including a common radio transceiver and signal processor and differ from the sensor modules and the responder modules in including specific functional variations.

By these means an extensive building management system may be built up readily and inexpensively from a number of essentially similar modules.

According to a third aspect of the invention there is provided a method of controlling facilities of a building in response to changes of a plurality of variables, which method comprises sensing said changes at a plurality of sensor locations, transmitting control signals representing said changes to a plurality of facility locations for control of facilities thereat and transmitting management signals between the sensor locations and the facility locations, characterised in that all said signals are wireless.

In this method at least some of said variables may of different kinds, and thus, for example, the control signals may comprise signals representing occupancy of the building, ambient temperature, ambient light level, power supply and/or time. The management signals may comprise signals representing the locations, status of facilities at the locations, requests for said status, facility correction and/or status confirmation.

Preferably at least some of said signals are transmitted by way of a central location, where they may be monitored. Also, additional signals may be transmitted from the central location, eg control signals, management signals or signals comprise signals operative to alter the sensing and/or the control of facilities.

Preferably signals when received are subjected to a cyclical redundancy check in which an algorithm is applied to generate a comparison for the received signal.

Other features of the present invention will be apparent from the following description, which is made by way of example only with reference to the accompanying schematic drawings in which

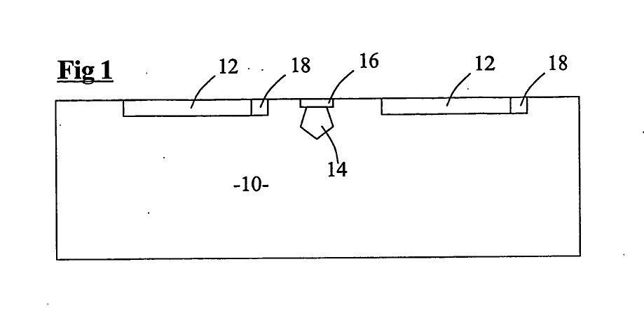

FIG. 1 outlines a simple lighting control system embodying the invention and comprising one controller module and two responder modules;

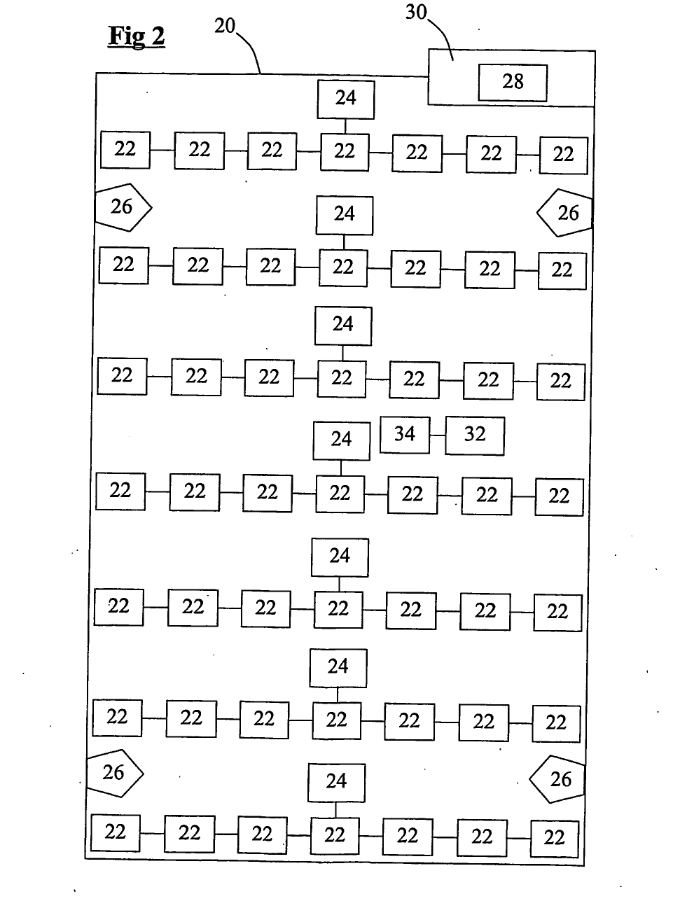

FIG. 2 is plan view of a sports hall with lighting controlled by an extended lighting control system embodying the invention;

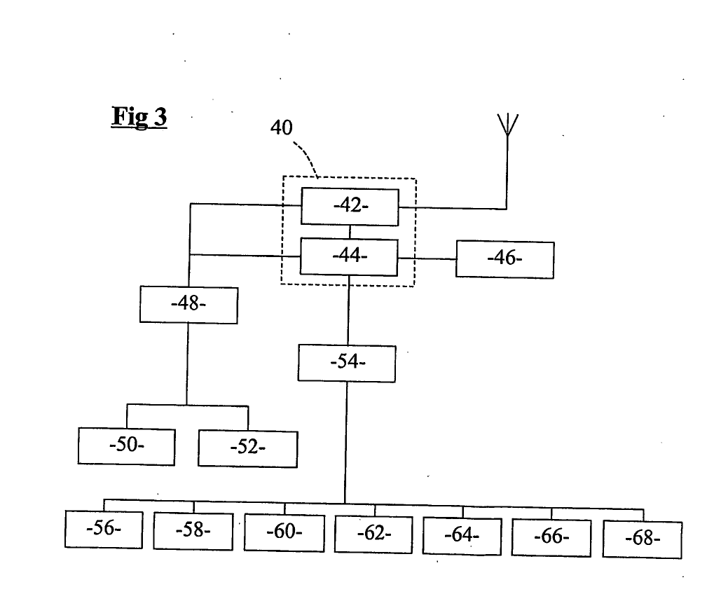

FIG. 3 illustrates a control device for the system of FIG. 2;

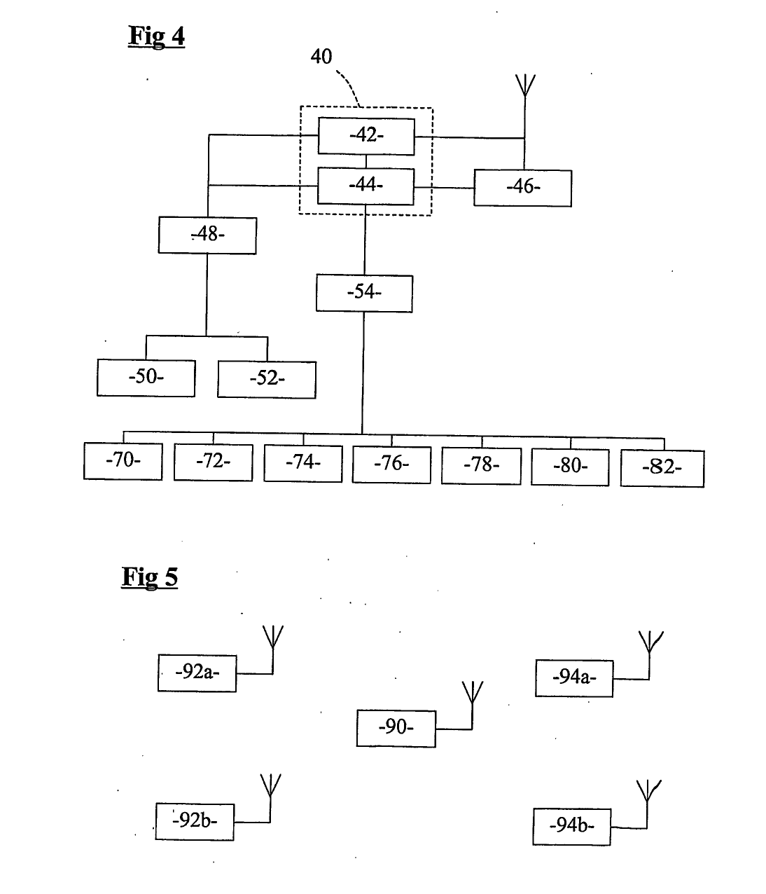

FIG. 4 illustrates a control device like that of FIG. 3 adapted to the control of a variety of apparatus including units other than lighting units; and

FIG. 5 illustrates an embodiment of the invention with an assortment of sensor modules.

Referring first to FIG. 1, this shows a room 10 of a building equipped with two overhead lights 12. Prior to the introduction of the invention to the room 10, the lights 12 were operable from either of two wall switches located at opposite ends of the room 10, but despite the apparent convenience of this arrangement the lights 12 were often left on unnecessarily. Accordingly the lights 12 now operate in response to a PIR sensor module 14 located and arranged to detect any person in the room 10. When this happens a controller module 16 (to be described in more detail hereinafter) associated with the sensor module 14 transmits a radio-frequency control signal from the sensor location. This control signal is received by a responder module 18 (also to be described in more detail hereinafter) at a location away from the sensor location and operatively associated with each light 12 and causes a switch in the lighting power supply to be closed automatically, switching the lights 12 on. When the detected person leaves the room 10, the lights 12 are automatically switched off. Thus power is saved.

A particular advantage of arrangements such as that of FIG. 1 is that automatic operation of lights may be provided without expensive rewiring, because the sensor module 14 can be located for best visibility without concern for the location of the lights.

Whilst the simple system of FIG. 1 has considerable benefits in convenience and cost, it should be pointed out that the invention can be extended to provide much more, and an example of larger scale control of lighting will now be described with reference to FIG. 2. This shows (not to scale) a sports hall 20 lit with a total of forty-nine fluorescent lighting units 22. Each lighting unit 22 comprises three 80W tubes and an associated dimmable ballast.

The lighting units 22 are arranged as seven each of seven units, and it was decided to connect each row to one responder module 24. The sports hall 20 therefore has seven lighting responder modules each switching 1680 W (=7×3×80), ie a current of 7 A at 240V mains supply (excluding current requirements of the digital dimmable ballasts).

Four microwave/PIR motion sensor modules 26 are located to cover the area of the sports hall 20. Any one of the sensor modules 26 that detects a movement within the sports hall 20 transmits a radio signal representing the same to a controller module 28, and the controller module 28 then transmits a control signal by radio to the responder modules 24, causing them to switch their associated lighting units on (or keep them on) and then increase their brightness to a preset level.

The controller module 28 includes a light-dependent resistor to sense ambient light level. The controller module 28 transmits a signal representing the sensed light level to the responder modules 24 to control the lighting units 22 accordingly. Thus the output of the lighting units 22 can be automatically increased as ambient light level fall and decreased as ambient light level rises.

An emergency lighting responder module 32 is connected to an emergency lighting unit 34 to operate the emergency lighting unit 34 if a signal is received from a power failure sensor module. The power failure sensor module includes three relays, one for each phase of the power supply. The three relays are arranged in series between two terminals. When mains power is present, all three relays are closed to provide a short circuit between the two terminals. An interruption in any phase causes the respective relay to open, and the circuit between the terminals being now open, this is detected to trigger transmission of a corresponding control signal to the responder module 32, which turns on the emergency lighting unit 34. (It is to be understood that the three relays may be connected in parallel, in which case the emergency lighting unit is switched on only if all three phases fail). Either arrangement requires a mains-independent source of power, such as a rechargeable battery and a charger circuit.

Neither the light sensing arrangement nor the emergency lighting arrangement is detailed in the drawings, but it is considered that those skilled in the science will be readily able to design and construct suitable circuits.

It should be noted that all communication among the sensor modules 26, the controller module 28 and the responder modules 24, 32 is by radio. The controller module 28 is located outside the sports hall 20, in a supervisor's office 30.

Although not detailed in FIG. 2, the controller module 28 includes manual lighting control that can be used to adjust the lighting level for the sports hall 20, from 30% up to 100%. It also includes emergency lighting control for setting all lights to maximum power in case of an emergency and a remote lighting override operable to override the motion sensor modules in case lighting is needed when the sports hall is unused. The control system for this system thus has eight responder modules, four motion sensor modules and one controller module, with a total of thirteen radio transceivers.

FIG. 3 illustrates the design of a device (either controller module or responder module) for use in the system of FIG. 2. The system operates at 868 MHz, which is a standard frequency (at least in Europe) for short range devices.

The device of FIG. 3 provides two-way wireless communication by means of a transceiver 40 comprising a radio device 42 operatively connected to a microcontroller 44. The radio device 42 is an RF211 chip and the processor 44 is an AT mega 16 microcontroller chip, both of which items are supplied by Atmel, but those skilled in the science will appreciate that other units may be used. The transceiver 40 is constructed as a single multi-layer printed circuit board incorporating both the radio communication and microcontroller functions. An ISP programmer (STK500) 46 is operatively associated with the processor 44. The same board design is used in all controller modules and responder modules, but with firmware tailored to its role. Thus, for example, a responder module has firmware enabling it to receive digital commands from a controller module, act on those commands and, if necessary, reply to them or repeat them to other devices in the system. (All responder modules in the system can be arranged to act as repeaters within the system, relaying signals to other responder modules which may be out of range of the originating device, but this function can be inhibited, as will be described later herein). Each device also includes a common power supply unit 48 arranged to deliver 3.3V from either electrical mains 50 or battery 52 supply. Each device has an individual identifier (ID) stored within it during production and used for addressing.

Each responder module is given specific functionality in the control system by the addition of one or more functional variations operative through the microcontroller 44 by way of an input/output serial port 54 supporting Hyperterminal communication. The various functional variations comprise manual lighting control 56, light level sensing 58, motion sensing 60, power failure response 62, fluorescent lighting control 64, emergency lighting control 66 and remote lighting override 68.

Controller Module

Embodied as a controller module, the device includes an array of buttons (not detailed in FIG. 3) enabling a user to operate the control system and a panel of light emitting diodes (LEDs) providing user information about the system. Normally the buttons cause a SWITCH ON or SWITCH OFF command to be broadcast to the responder modules of the system, and the LED display shows when the command has been successfully executed. Facilities to reset and configure the system are also provided, and an RS232 interface allows connection to a general purpose PC running, for instance, a building management program.

The function of the controller module is to turn a set of responder modules on and off. There are four ways that this function can be achieved, as follows.

First, the controller module may be operated manually by means of the buttons, and this takes immediate effect regardless of any other setting.

Second, the system may be operated by way of a first connection (which may be designated BMS1 for convenience) to a building management system. Normally, an intruder alarm will be connected to BMS1 so that when the alarm is set (when the premises are vacated for example) the alarm system will provide an open circuit on BMS1 and the transmitter will turn the responder modules off. When the alarm system is turned off it will provide a closed circuit on BMS1, and the controller module will turn the responder modules back on.

Third, the system may be operated by way of a second connection (BMS2) to the building management system. A time clock will normally be connected to BMS2. As with BMS1, an open circuit on BMS2 will instruct the controller module to turn the responder modules off and a closed circuit to turn the responder modules on. The system is arranged so that turning the responder modules off via BMS1 takes priority over BMS2. If there is no burglar alarm, then a wire link is placed across BMS1 if the time clock is connected to BMS2, or alternatively the time clock may be connected to BMS1.

Fourth, the system may be operated by way of an RS232 serial computer link. Commands to turn the responder modules on and off, individually or as a complete set, are supplied to the controller module via the RS232 connection, and status information may be obtained in a similar way. Configuration of the system, such as the specification of identifiers of responder modules included within the scope of the controller module, may also be performed in this way.

The use of identifiers comprising four hexadecimal codes means that a controller module has a theoretical capacity to control up to 65,533 responder modules, although radio traffic considerations set a lower limit.

Responder Module

Each responder module 24 includes two operational amplifiers that provide an interface to up to dimmable ballasts of the lighting units 22. The interface uses the DSI protocol. Signals received by the responder module 24 contain a light level code, between 0 and 255, which is processed by the micro-controller and converted to control information in a suitable format. The microcontroller also has the opportunity, depending on the firmware used, to convert the linear light level information to a logarithmic value, so that the perceived output from the fluorescent light unit follows an apparently linear curve, eg when the system is operated by a manual control

The responder module 32 is adapted to run off a 12v DC emergency lighting circuit. It includes a current-limiting circuit, since batteries with a 35 Ah capacity, or greater, may be the power source. The responder module 32 switches the emergency lighting unit 34 on or off depending on signals received from a power failure sensor (see below).

Responder modules may have other functional variations. For instance, for switching apparatus other than lighting unit, a responder module may include a relay rated at 16 A to which a controlled unit of apparatus is connected. In this arangement unswitched mains supply also powers a transformer and rectifier circuit providing 12V to operate the relay, by way of a transistor, and to drive a 3.3V voltage regulator circuit for the transceiver. Such responder modules respond to messages from a controller module and open and close their relays accordingly. The controller module may interrogate the status of the responder module, addressing it by its individual identifier. The controller module can be arranged to instruct all responder modules within its range, or each responder module specifically using its individual identifier.

To extend the overall range of a control system according to the invention, all responder modules have the capability to act also as repeaters within the system, relaying messages to other responder modules which may be out of range of a controller module. Provision has been made to allow this function to be disabled either through hardware or software. A responder module with the repeat function enabled automatically repeats signals it receives except any specifically addressed to itself (ie including that responder's ID).

Responder modules also include a set of dip switches whereby they may be organised into groups or zones. The system provides up to 255 such sets. Group/zone organization may alternatively be provided through a computer link.

Master Control

The controller module 28 is the master control for the system of FIG. 2. It acts as a master unit for the lights 22 and also provides manual adjustment. It has the facility to adjust the lighting level for an entire area via a rotary control. There is an internal adjustment for maximum and minimum light levels, and an override switch that will turn on all lights at maximum power and override the motion sensor modules 26, if necessary to ensure the lighting stays on even when the room 20 is empty, for example in emergency situations. The activity of up the motion sensor modules 26 can be displayed on the front panel of the manual unit. The controller module 28 transmits radio control signals to the responder modules 24 and receives signals from the sensor modules 26.

The controller module 28 transmits control signals for the responder modules to act upon, and is able to transmit radio signals from its location as well as receiving radio signals. Controller modules use the same radio/processor and power supply modules, and may also be fitted with any of the following controls (in addition to a reset button which will be standard on all controller modules): (a) single on/off buttons, (b) multiple on/off buttons, (c) numeric key-pad, (d) computer RS232 interface, (e) temperature, PIR or other sensor module and (f) external system interface (eg for connection to an intruder alarm).

Reset Sequence: When the reset button is pressed, the controller module will, for 60 seconds, send out a global scan message (GSM) at 10 second intervals, and wait for a response containing a responder module ID, from all the responder modules within range. The controller module saves each individual ID in EEPROM memory (500 bytes available, with 2-byte IDs gives a maximum number of responder modules controlled by one controller module of 250). After 60 seconds, and on successful receipt of at least one valid ID number, the controller module turns on a green LED; otherwise it turns on a continuous red LED, indicating an error. Two minutes after such an error condition, the controller module will enter sleep mode, when the LED begins to flash. On pressing the reset button again, the controller module leaves sleep mode, the LED is extinguished and the above procedure is repeated. On successful completion of the above routine, indicated by the green LED, the controller module proceeds to verify each responder module for which it has obtained an ID in turn, by sending a specific status request message (SSR) and receiving back a valid response. The status of each responder module is stored in a status array held in SRAM memory. When all the responder modules in its list have been verified, the controller module enters sleep mode until the reset button is pressed again, or one of the command buttons is pressed. The reset button is shielded to prevent accidental operation.

Light level Command: When the switch on button is pressed, the device transmits two different signals. The first signal sent is a global switch on command (GSO), which contains the controller module's ID number. This signal is repeated four times at an interval of 0.1 seconds. The second set of signals is addressed to each responder module in the controller module's list in turn, requesting its status (SSR). After each signal, the controller module waits for 0.1 seconds to receive a response (SRR), which if valid and correct will update a flag for that responder module in the status array. If the response indicates that the responder module is in the wrong state, a specific switch on command will be sent (SSO) and a response awaited for 0.1 seconds. This is repeated until all responder modules have been contacted and confirmed that they are switched on. Any not responding are retried up to five times before being marked as faulty in the status array.

Switch Off Command: When the switch off button is pressed, the device again transmits two different signals. The first signal sent is a global switch off command (GSX), which contains the controller module's ID number. This signal is repeated four times at an interval of 0.1 seconds. The second set of signals is addressed to each responder module in the controller module's list in turn, requesting its status (SSR). After each signal, the controller module waits for 0.1 seconds to receive a response, which if valid and correct will update a flag for that responder module in the status array. If the response indicates that the responder module is in the wrong state, a specific switch off command will be sent (SSX) and a response awaited for 0.1 seconds. This is repeated until all responder modules have been contacted and confirmed that they are switched off. Any not responding will be retried up to five times before being marked as faulty in the status array.

Multiple on/off buttons: Responder modules are manufactured with sequential serial numbers, but controller modules are not. Statistically, systems according to the invention have four or more responder modules for each controller module, so controller module serial numbers are incremented by 4. With two-byte ID numbers this gives a system-wide maximum of 16,384 controller modules. On devices fitted with only single on/off switches the serial number is also be the controller module's ID number, but where multiple switches are fitted, it is the ID number used only by a first pair of switches. A second pair of switches uses the serial number plus 1, a third pair uses the serial number plus 2 and a fourth pair uses the serial number plus 3. In this way, all controller module devices are identical from the hardware and firmware point of view apart from the number of switches fitted, and any controller module has the potential to control up to four different user-defined sets of responder modules.

Computer interface: Responder modules can be programmed individually during production, or with specialist equipment after production, but controller modules are equipped with an RS232 (or optionally USB) serial interface to allow one or more responder modules to be programmed through the use of a general purpose PC with suitable software. Access to the PC software is restricted by password security for example, and links to other computer systems are possible. The software enables a user to associate responder modules with one or more controller modules, by storing the respective unique controller module IDs in the responder module's EEPROM memory, again up to a maximum of 250. Without such information, the responder module would respond to any controller module from which it received a valid signal, and it is therefore conceivable that two separate installations in close proximity could interfere with each other. This associative feature not only prevents such an eventuality, but also allows responder modules to be organised in sets, responding only to one or more controller modules. For example, if three groups were required, the responder modules could be programmed to respond only to the controller module for their group. Some responder modules may be members of two or three groups if required, and one controller module can be defined as a master, to which responder modules in all three groups respond. The computer link can also be used to set a repeat inhibit indicator in a responder module's EEPROM memory, to prevent that responder module from operating as a repeater. Because the number of messages propagated by the responder modules in an installation grows exponentially with the number operating as repeaters, it may be necessary, in large installations at least, to switch some of the repeaters off. The choice of which responder modules should function as repeaters depends upon the locations of the various devices within an installation, and is determined on site.

Light Level Responder

Light level response is provided in a controller module 28 by a light-sensitive resistor (not detailed in the drawings). This resistor monitors ambient light levels and, via an Atmel ATTINY microprocessor, which acts as an analogue to digital converter, passes a light level code to the micro-controller of the controller module 28. This code is transmitted to whichever unit in the system is acting as the “master” unit (if there is more than one) and signals to control the lighting units 22 accordingly are transmitted to the responder modules 24.

A controller module with the light level functional variation may be separate from the master controller module 28. In this case it operates as a slave in the system, responding to control signals from the master controller module 28 and if necessary repeating them. The module is able to transmit radio signals from its location as well as receiving radio signals.

Power-up Sequence: On initial power-up, the device waits for a command from a controller module device.

Switch On Response: On receipt of a valid global switch on command (GSO), the device updates its status, stored in SRAM, and proceeds to switch on its associated relay, after a delay based on the responder module's serial number to avoid a power surge. On receipt of a valid specific switch on command (SSO), the device updates its status, responds with a status request response message (SRR) and then switches on the relay after a delay based on the responder module's serial number.

Switch Off Response: On receipt of a valid global switch off command (GSX), the device updates its status, stored in SRAM, and proceeds to switch off its relay, after a delay based on the responder module's serial number. On receipt of a valid specific switch off command (SSX), the device updates its status, responds with a status request response message (SRR) and then switches off the relay after a delay based on the responder module's serial number.

Polling Response: On receipt of a valid global scan message (GSM), the device waits for a set period of time (based on its unique serial number) before transmitting a global scan response message (GSR) containing its unique serial number and the serial number of the controller module it is responding to.

Repeater Function: All light level responder modules have the capacity to act as repeaters, and all valid messages are repeated unless (a) the repeat inhibit indicator has been turned on for this device or (b) the message is specifically for this responder module or (c) the message has already been repeated by this responder module or (d) the message has reached the maximum allowed number of repeats (i.e.16). Original messages can be identified by the presence of only one originating controller module or responder module ID. In the case of specific messages, these also contain the ID of the responder module being addressed. The outgoing repeated message has the ID of the repeater appended after the controller module ID. A message that is not original is repeated provided the responder module's ID is not already appended to the message (i.e. this responder module has not repeated this message before).

Motion Detection

Each motion sensor module 26 is a modification of the responder module 24 in which the relay and transistor driver are removed and a PIR/microwave motion sensor inserted with the relay's power supply has been diverted to drive the sensor, and also adapted to run from a 12v DC supply or suitable mains power adaptor. A relay in the motion sensor, which is normally closed, opens when motion is detected, and this information is fed, via the microcontroller to the transceiver device, which in turn transmits a signal to the master controller module. Depending on other factors such as light level and manual settings, the master controller module 28 may instruct the lighting units 22 to come on. The detection is also displayed on the display panel of the master controller module 28.

Power Failure

Power failure response is provided in a controller module (the same as or separate from the controller 28) including a relay between two terminals S1 and S2 in the mains power supply line. For three-phase power supply, there are three relays RL1, RL2 and RL3, one for each phase. When mains power is present, all the relays RL1, RL2 and RL3 are closed, so that the connection between S1 and S2 is a short circuit. If any one phase of the mains power supply fails, then the respective relay opens, thus creating an open circuit. This is detected by the micro-controller of the controller module, resulting in a “power failure” signal being transmitted to the emergency lighting responder module 32. This in turn causes the emergency lighting 34 to be switched on. (The sensing circuit may alternatively be wired with the relays in parallel, rather than in series, to detect and signal power failure only when all phases of the mains supply have failed. By its nature, a controller module including the power failure functional variation requires an external power supply and it is therefore fitted with a rechargeable 9v battery and charger circuit which keeps the battery charged when mains power is present.

A controller module with the power failure functional variation may be separate from the master controller module 28. In this case it operates as a slave in the system, responding to control signals from the master controller module 28 and if necessary repeating them. The module is able to transmit radio signals from its location as well as receiving radio signals.

Power-up Sequence: On initial power-up, the device waits for a command from a controller module.

Switch On Response: On receipt of a valid global switch on command (GSO), the device updates its status, stored in SRAM, and proceeds to switch on its associated relay, after a delay based on the responder module's serial number to avoid a power surge. On receipt of a valid specific switch on command (SSO), the device updates its status, responds with a status request response message (SRR) and then switches on the relay after a delay based on the responder module's serial number.

Switch Off Response: On receipt of a valid global switch off command (GSX), the device updates its status, stored in SRAM, and proceeds to switch off its relay, after a delay based on the responder module's serial number. On receipt of a valid specific switch off command (SSX), the device updates its status, responds with a status request response message (SRR) and then switches off the relay after a delay based on the responder module's serial number.

Polling Response: On receipt of a valid global scan message (GSM), the device waits for a set period of time (based on its unique serial number) before transmitting a global scan response message (GSR) containing its unique serial number and the serial number of the controller module it is responding to.

Repeater Function: All power failure responder modules have the capacity to act as repeaters, and all valid messages are repeated unless (a) the repeat inhibit indicator has been turned on for this device or (b) the message is specifically for this responder module or (c) the message has already been repeated by this responder module or (d) the message has reached the maximum allowed number of repeats (i.e.16). Original messages can be identified by the presence of only one originating controller module or responder module ID. In the case of specific messages, these also contain the ID of the responder module being addressed. The outgoing repeated message has the ID of the repeater appended after the controller module ID. A message that is not original is repeated provided the responder module's ID is not already appended to the message (i.e. this responder module has not repeated this message before).

Lighting Unit Response

Although not detailed in the drawings, each lighting responder module 24 includes two operational amplifiers providing a DIS protocol interface to the dimmable ballasts of the associated lighting units 22. Control signals received by a lighting responder module 24 include a light level code (between 0 and 255) that is processed by the microcontroller 44 (FIG. 3) and converted to digital information in the so-called Manchester code. Optionally, the microcontroller 44 can be arranged to convert the linear light level information to logarithmic values, whereby the output from the lighting units 22 is perceived by users of the sports hall 20 to vary substantially linearly.

The lighting unit responder module functions as a slave in the system, responding to control signals from the controller module and if necessary repeating them. The responder module is able to transmit radio signals from its location as well as receiving radio signals.

Power-up Sequence: On initial power-up, the device waits for a command from a controller module.

Switch On Response: On receipt of a valid global switch on command (GSO), the device updates its status, stored in SRAM, and proceeds to switch on its associated relay, after a delay based on the responder module's serial number to avoid a power surge. On receipt of a valid specific switch on command (SSO), the device updates its status, responds with a status request response message (SRR) and then switches on the relay after a delay based on the responder module's serial number.

Switch Off Response: On receipt of a valid global switch off command (GSX), the device updates its status, stored in SRAM, and proceeds to switch off its associated relay, after a delay based on the responder module's serial number. On receipt of a valid specific switch off command (SSX), the device updates its status, responds with a status request response message (SRR) and then switches off the relay after a delay based on the responder module's serial number.

Polling Response: On receipt of a valid global scan message (GSM), the device waits for a set period of time (based on its unique serial number) before transmitting a global scan response message (GSR) containing its unique serial number and the serial number of the controller module it is responding to.

Repeater Function: All lighting unit responder modules have the capacity to act as repeaters, and all valid messages are repeated unless (a) the repeat inhibit indicator has been turned on for this device or (b) the message is specifically for this responder module or (c) the message has already been repeated by this responder module or (d) the message has reached the maximum allowed number of repeats (i.e.16). Original messages can be identified by the presence of only one originating controller module or responder module ID. In the case of specific messages, these also contain the ID of the responder module being addressed. The outgoing repeated message has the ID of the repeater appended after the controller module ID. A message that is not original is repeated provided the responder module's ID is not already appended to the message (i.e. this responder module has not repeated this message before).

Emergency Lighting Response

The emergency lighting responder module functions as a slave in the system, responding to control signals from the controller module and if necessary repeating them. The responder module is able to transmit radio signals from its location as well as receiving radio signals.

Power-up Sequence: On initial power-up, the device waits for a command from a controller module.

Switch On Response: On receipt of a valid global switch on command (GSO), the device updates its status, stored in SRAM, and proceeds to switch on its associated relay, after a delay based on the responder module's serial number to avoid a power surge. On receipt of a valid specific switch on command (SSO), the device updates its status, responds with a status request response message (SRR) and then switches on the relay after a delay based on the responder module's serial number.

Switch Off Response: On receipt of a valid global switch off command (GSX), the device updates its status, stored in SRAM, and proceeds to switch off its associated relay, after a delay based on the responder module's serial number. On receipt of a valid specific switch off command (SSX), the device updates its status, responds with a status request response message (SRR) and then switches off the relay after a delay based on the responder module's serial number.

Polling Response: On receipt of a valid global scan message (GSM), the device waits for a set period of time (based on its unique serial number) before transmitting a global scan response message (GSR) containing its unique serial number and the serial number of the controller module it is responding to.

Repeater Function: All emergency lighting responder modules have the capacity to act as repeaters, and all valid messages are repeated unless (a) the repeat inhibit indicator has been turned on for this device or (b) the message is specifically for this responder module or (c) the message has already been repeated by this responder module or (d) the message has reached the maximum allowed number of repeats (i.e.16). Original messages can be identified by the presence of only one originating controller module or responder module ID. In the case of specific messages, these also contain the ID of the responder module being addressed. The outgoing repeated message has the ID of the repeater appended after the controller module ID. A message that is not original is repeated provided the responder module's ID is not already appended to the message (i.e. this responder module has not repeated this message before).

Manual Control

The controller module 28 may include a functional variation enabling manual override of the automatic features of the lighting control system, such as adjustable lighting levels and motion sensing. It may be used in emergency situations, or where there is a need to temporarily switch on the lighting at full power.

A controller module with the manual control functional variation may be portable, powered by a 9V battery.

A separate controller module with the manual control functional variation operates as a slave in the system, responding to control signals from the master controller module 28 and if necessary repeating them. The module is able to transmit radio signals from its location as well as receiving radio signals.

Power-up Sequence: On initial power-up, the device waits for a command from a controller module.

Switch On Response: On receipt of a valid global switch on command (GSO), the device updates its status, stored in SRAM, and proceeds to switch on its associated relay, after a delay based on the responder module's serial number to avoid a power surge. On receipt of a valid specific switch on command (SSO), the device updates its status, responds with a status request response message (SRR) and then switches on the relay after a delay based on the responder module's serial number.

Switch Off Response: On receipt of a valid global switch off command (GSX), the device updates its status, stored in SRAM, and proceeds to switch off its associated relay, after a delay based on the responder module's serial number. On receipt of a valid specific switch off command (SSX), the device updates its status, responds with a status request response message (SRR) and then switches off the relay after a delay based on the responder module's serial number.

Polling Response: On receipt of a valid global scan message (GSM), the device waits for a set period of time (based on its unique serial number) before transmitting a global scan response message (GSR) containing its unique serial number and the serial number of the controller module it is responding to.

Repeater Function: All override responder modules have the capacity to act as repeaters, and all valid messages are repeated unless (a) the repeat inhibit indicator has been turned on for this device or (b) the message is specifically for this responder module or (c) the message has already been repeated by this responder module or (d) the message has reached the maximum allowed number of repeats (i.e.16). Original messages can be identified by the presence of only one originating controller module or responder module ID. In the case of specific messages, these also contain the ID of the responder module being addressed. The outgoing repeated message has the ID of the repeater appended after the controller module ID. A message that is not original is repeated provided the responder module's ID is not already appended to the message (i.e. this responder module has not repeated this message before).

Programming Considerations

To provide individual IDs, responder modules are programmed with consecutive serial numbers in the range 0 to 65,535 and controller modules are programmed with serial numbers incremented by 4 in the range 0 to 65,532. These serial numbers are also printed on a label on the individual modules, and it is not possible for the user to change these numbers.

In the event of a power cut, responder modules revert to their initial state, i.e. with their connected apparatus switched off. On restoration of mains power they switch on until they receive a command from an associated controller module to switch off again. The main reason for this is that the responder module's status is held in SRAM, and this information is lost in a power failure. Maintaining the status in the nonvolatile EEPROM is not recommended due to the limited number of times such memory can be written to. Battery powered controller modules are not affected by interruptions to the mains supply, but after a battery is discharged, or disconnected for whatever reason, and then reconnected, the controller module goes through its reset routine.

Configuration of a control system according to the invention system is simplified by the use of a controller module equipped with an RS232 serial interface, allowing it to be connected to a PC (universally available at modest price). Software has been developed to acquire details of all responder modules within range of a controller module, and allow the installer to specify any desired grouping of those responder modules, and also provide a facility to inhibit the repeater function of any of them.

Other Control Systems

The invention is not limited to lighting control, and its extension to other applications will now be discussed with reference to FIGS. 4 and 5.

Referring first to FIG. 4, this shows how a controller module or responder module of the invention can be adapted to the control of a wide variety of apparatus by means of different function modules. Comparing FIG. 4 with FIG. 3, the device of FIG. 4 includes a transceiver 40 comprising a radio device 42 operatively connected to a microcontroller 44, an ISP programmer (STK500) 46, a power supply unit 48, electrical mains input 50 and a battery supply 52 the same as the device of FIG. 3. As in FIG. 3, the device of FIG. 4 also has an individual ID stored within it during production and used for addressing.

Each device is given specific functionality by the addition of one or more function modules coupled to the microcontroller 44 by way of an input/output serial port 54 supporting Hyperterminal communication. In the case of the device of FIG. 4 these function modules comprise a keypad 70, a button panel 72, an array of LEDs 74, an LCD display 76, a computer interface 78, relay connections 80 and sensor modules 82.

FIG. 5 shows a control system comprising a controller module 90, two sensor modules 92a and 92b and two responder modules 94a and 94b respectively corresponding to the sensor modules 92a and 92b. All these modules are generally of the form shown in FIG. 4 and in particular each includes a transceiver. The sensor modules 92a and 92b each also include a sensor and the responder modules 94a and 94b each also include a 16 A relay. (The sensors and relays are not detailed in FIG. 5). For the sake of explanation it will be assumed that the sensor of the sensor module 92a is a PIR movement detector, that the relay of the responder module 94a controls an electrical lighting unit (not shown) in a first room, that the sensor of the sensor module 92b senses ambient temperature and that the relay of the responder module 94b controls an electrical heater in a second room.

Initially, both of the first and second rooms are taken to be unoccupied. If a person enters the first room, this is sensed by the PIR detector and the transceiver of the sensor module 92a transmits a radio signal representative of that. This signal is received by the transceiver in the controller module 90 and this in turns transmits a respective control signal. The control signal is received by the responder module 94a and the relay thereof is then actuated to switch on the lights in the first room. In much the same way, if the ambient temperature in the second room falls below a certain level, this is sensed by the sensor incorporated in the sensor module 92b and the transceiver thereof transmits a signal representative of that. This signal is received by the transceiver in the controller module 90 and this in turn transmits a respective control signal. This control signal is received by the responder module 94b and the relay thereof is then actuated to switch on the heater in the second room. It is to be noted that there is no wired communication among the controller module 90, the sensor modules 92a, 92b and the responder modules 94a, 94b.

Those skilled in the science will appreciate that various modifications and adaptations of the system as described may be made without departing from the essence of the invention. For instance, there may be other, possibly many, sensor modules sensing other variables and other responder modules controlling different devices. A personal computer connected to the system may be provided with a graphical user interface to aid management. Subject to the provision of a satisfactory antenna, a controller module may be incorporated in a personal computer to facilitate control. And where proportional control is required, relays may be replaced by suitable control mechanisms as outlined in our copending international patent application PCT/GB2004/003427.

1-70. (canceled)

71. A control system for controlling apparatus remotely in response to changes of a variable, which control system comprises a sensor module to sense the variable, a controller module operatively associated with the sensor module and including a radio transceiver operative to transmit a control signal when the variable changes and to transmit and receive system management signals, and a responder module arranged remote from the controller module and including a radio transceiver operative to receive the control signal and to receive and transmit system management signals, wherein the system is programmable to define the control signal.

72. A control system as claimed in claim 71 wherein said sensor module senses an electrical input.

73. A control system as claimed in claim 72 wherein the electrical input is generated when an intruder alarm is switched on or off.

74. A control system as claimed claim 72 wherein the electrical input is generated by a building management system.

75. A control system as claimed in claim 71 wherein said sensor module senses a natural variable.

76. A control system as claimed in claim 71 wherein the responder module is programmable to function as a repeater for said signals.

77. A control system as claimed in claim 71 wherein the radio transceiver of the controller module is of the same form as the radio transceiver of the responder module.

78. A control system as claimed in claim 71 for controlling apparatus comprising a plurality of units wherein the system comprises a plurality of said sensor modules respectively responsive to a plurality of said variables and a plurality of responder modules respectively associated with said units.

79. A control system as claimed in claim 78 wherein at least some of said sensor modules sense mutually different variables.

80. A control system as claimed in claim 79 wherein the system management signals include identity signals individual to the responder modules.

81. A control system as claimed in claim 80 wherein the system management signals include identity signals individual to a set of responder modules arranged in a group or a zone, which set operate together.

82. A control system as claimed in claim 78 wherein the controller module includes a status array recording the proper status of the responder modules.

83. A control system as claimed in claim 82 wherein the system includes reset means operative to check the actual status of each responder module against the recorded status and to indicate any discrepancy.

84. A control system as claimed in claim 78 wherein the controller module is operative to control units of the controlled apparatus by transmitting a global switch control signal associated with the identity signals of the corresponding responder modules followed by status request signals to those responder modules seriatim.

85. A control system as claimed in claim 84 wherein each responder module is arranged to respond to its status request signal by transmitting an actual status signal for receipt by the controller module and comparison with the record in the status array.

86. A control system as claimed in claim 85 wherein, if for any responder module there is a discrepancy between the actual status and the record, the controller module transmits a correction signal to change the status of that responder module to its proper status.

87. A control system as claimed in claim 86 wherein on receipt of the correction signal the responder module transmits a confirmation signal to the controller module.

88. A control system as claimed in claim 87 wherein the responder module concerned is recorded as faulty if no confirmation signal is received by the controller module.

89. A control system as claimed in claim 78 wherein said system includes a computer whereby the controller module is programmed and an interface whereby control and/or management information of the system is delivered to and/or from the computer.

90. A control system as claimed in claim 89 wherein said computer is programmable to provide a schedule under which the control varies with time.

91. A control system as claimed in claim 89 wherein the computer is programmable to partition the system into groups and/or zones.

92. A control system as claimed in claim 89 wherein the computer is programmable to define individual identities for the responder modules.

93. A control system as claimed in claim 89 wherein the computer is programmable to define the response of a specific responder module.

94. A control system as claimed in claim 89 wherein the system comprises a plurality of said controller modules.

95. A control system as claimed in claim 78 wherein the system is configured and arranged to operate as a building management system in which all communication among the sensor modules, the responder modules and the or each controller module is wireless.

96. A building management system comprising a plurality of sensor modules operative at a plurality of sensor locations to sense one or more variables, each sensor module being associated with a radio transmitter operative in use to transmit from the sensor location radio control signals related to its sensed variable, a plurality of responder modules operative at a plurality of responder locations to control apparatus, each responder module in use receiving radio control signals related to the variables sensed by the sensor modules and controlling said apparatus automatically in response thereto, the sensor modules and responder modules being mutually similar in including a common radio transceiver and signal processor and mutually different in including specific functional variations, and a controller module operatively associated the sensor modules, which controller module is programmable to define the control signals.

97. A building management system as claimed in claim 96 wherein the controller module receives radio control signals from the sensor modules and transmits radio control signals to the responder modules is similar in form to the sensor modules and the responder modules.

98. A building management system as claimed in claim 96 wherein the controller module has a functional variation comprising a manual control operable to adjust output from the controlled apparatus.

99. A building management system as claimed in claim 96 wherein the controller module has a functional variation comprising a display panel operative in use to show the operative status of sensor modules and/or responder modules.

100. A building management system as claimed in claim 96 including a portable controller module.

101. A method of controlling facilities of a building in response to changes of a plurality of variables, which method comprises (a) sensing said changes at a plurality of sensor locations, (b) programmably defining control signals representing said changes, (c) transmitting the defined control signals from the sensor locations to a plurality of facility locations for control of facilities thereat, and (d) transmitting management signals between the sensor locations and the facility locations, wherein all said control signal and management signals are wireless.

102. A method of controlling facilities of a building as claimed in claim 101 wherein the control signals comprise signals representing occupancy of the building, ambient temperature, ambient light level, power supply and/or time.

103. A method of controlling facilities of a building as claimed in claim 102 wherein the management signals comprise signals representing said locations, status of facilities at said locations, requests for said status, facility correction and/or status confirmation.

104. A method of controlling facilities of a building as claimed in claim 101 wherein at least some of said signals are transmitted by way of a central location whereat said signals are monitored by a cyclical redundancy check.

105. A method of controlling facilities of a building as claimed in claim 103 wherein the definition of the control signals is programmed from said central location.
